(19) United States
(12) Patent Application Publication
(10) Pub. No.: US 2018/0061519 A1
(43) Pub. Date: Mar. 1, 2018

(54) CONDUCTIVE RESIN COMPOSITION AND ELECTRONIC CIRCUIT MEMBER USING THE SAME

(71) Applicant: PANASONIC INTELLECTUAL PROPERTY MANAGEMENT CO., LTD., Osaka (JP)

(72) Inventors: Takatoshi ABE, Osaka (JP); Tomoaki SAWADA, Osaka (JP)

(73) Assignee: PANASONIC INTELLECTUAL PROPERTY MANAGEMENT CO., LTD., Osaka (JP)

(21) Appl. No.: 15/692,492

(22) Filed: Aug. 31, 2017

(30) Foreign Application Priority Data
Sep. 1, 2016 (JP) 2016-170687

(51) Int. Cl. H01B 1/12; C08F 12/08; C08F 20/14; C08F 20/44

(52) U.S. Cl. CPC H01B 1/125; C08F 12/08; C08F 2500/01; C08F 20/44; C08F 20/14

(57) ABSTRACT

The present invention relates to a conductive resin composition comprising, as essential components, a resin (A), a curing agent (B) reacting with the resin (A), and a conductive filler (C), wherein the resin (A) has a functional group, a functional group equivalent of 400 g/eq or more and 10,000 g/eq or less, a Tg (glass transition temperature) or a softening point of 40° C. or less, or an elastic modulus of less than 1.0 GPa at 30° C., and wherein the conductive filler (C) is made of a conductive material having a volume specific resistivity of 1×10⁻⁴ Ω·cm or less at room temperature.

### CROSS-REFERENCE TO RELATED APPLICATIONS

This application claims the benefit of Japanese Application No. 2016-170687 filed on Sep. 1, 2016, which is incorporated herein by reference in its entirety.

### FIELD OF THE INVENTION

The present invention relates to a conductive resin composition having flexibility and suppressing change in conductivity at the time of extension, and an electronic circuit member using the same.

### BACKGROUND OF THE INVENTION

In the field of electronics, particularly in applications such as sensors, displays, artificial skins and artificial muscles for robots, flexible devices which can be placed on curved surfaces, irregular surfaces, etc. and freely deformed are being required. Although organic transistors and the like dealing with such a request have been studied, flexibility is also required for substrates and wiring used for devices. Regarding wiring in particular, there is no flexibility in conventional metal circuits, and thus development of flexible wiring is becoming necessary.

As a conventional conductive paste, a lot of pastes filled with a conductive filler such as silver powder based on an epoxy resin excellent in heat resistance have been developed, but there was a problem that the epoxy resin is poor in the flexibility due to its hard and brittle properties, as well as poor in the followability to deformation. On the other hand, in a report focusing solely on flexibility, a conductive material in which a gel mixed with carbon nanotubes and an ionic liquid is dispersed in rubber has been proposed, but its conductivity is far behind the conventional metal wiring.

In order to satisfy both conductivity and stretchability, a conductive paste combining a flexible thermoplastic elastomer and a metal powder, and a circuit board printed on a flexible substrate using a conductive paste have been reported (JP2015-178597A and JP2012-54192A). However, with these methods, since the thermoplastic elastomer serves as a binder for the conductive filler, there is a drawback that such an elastomer is greatly influenced in a heat-resistant environment and the restorability after plastic deformation is poor. For this reason, it is difficult to achieve the same level of quality in conductivity and stretchability as conventional ones about implementation in the electronics and long-term reliability.

In addition, there is a report in which conductivity and stretchability are further improved by using a predetermined resin and a conductive filler (JP2015-65139 A). Regarding this method as well, a thermoplastic elastomer whose main raw material is a rubber emulsion is responsible for stretchability. In particular, when a nitrile rubber emulsion is used, it is difficult to satisfy restorability after deformation, heat resistance, and stretchability at the same time, depending on the content of nitrile group, and a problem of reduction in adhesion to the member when a silicone rubber emulsion is used has been pointed out.

The present invention has been made in view of the above-described circumstances, and it is an object of the present invention to provide a conductive resin composition capable of rendering a conductive pattern or the like by a method such as coating or printing, and excellent in conductivity, stretchability, and restorability after deformation, as well as to provide an electronic circuit member using the same.

### SUMMARY OF THE INVENTION

As a result of intensive studies, the inventors of the present invention have found that in the resin composition having the following constitution, stretchability and conductivity are compatible while maintaining good restorability after deformation and heat resistance of a curable resin, and have further studied based on these findings to arrive at the present invention.

That is, the conductive resin composition according to one aspect of the present invention contains, as essential components, a resin (A), a curing agent (B) reacting with the resin (A), and a conductive filler (C), wherein the resin (A) has a functional group, a functional group equivalent of 400 g/eq or more and 10000 g/eq or less, a Tg (glass transition temperature) or a softening point of 40° C. or less, or an elastic modulus of less than 1.0 GPa at 30° C., and wherein the conductive filler (C) is made of a conductive material having a volume specific resistivity of 1×10⁻⁴ Ω·cm or less at room temperature.

An electronic circuit member according to another aspect of the present invention is characterized by having a conductive pattern or a conductive film made of the conductive resin composition.

### DETAILED DESCRIPTION OF THE INVENTION

Hereinafter, embodiments of the present invention will be described in detail, but the present invention is not limited thereto.

The conductive resin composition of the present embodiment is characterized by containing, as essential components, a resin (A), a curing agent (B) reacting with the resin (A), and a conductive filler (C), wherein the resin (A) has a functional group, a functional group equivalent of 400 g/eq or more and 10000 g/eq or less, a Tg or a softening point of 40° C. or less, or an elastic modulus of less than 1.0 GPa at 30° C., and wherein the conductive filler (C) is made of a conductive material having a volume specific resistivity of 1×10⁻⁴ Ω·cm or less at room temperature.

According to the above constitution, it is possible to provide a conductive resin composition having good restorability after deformation, high heat resistance, electrical conductivity, and stretchability at the same time, and provide a circuit member made of the same. Further, by using the conductive resin composition or the circuit member having such characteristics, it is considered that various interface devices such as sensors and displays, which require mountability and shape followability, can be realized. In addition, it is also considered that the conductive resin composition of the present invention can be widely applied to applications requiring mountability and shape followability in flexible batteries including solar cells, medical fields, automotive fields, and the like.

Each component is described below.

<(A) Resin>

In the present embodiment, the resin (A) is characterized by having a functional group, and examples of the functional group include an epoxy group, a vinyl group, a (meth)acryloyl group, a hydroxyl group, a carboxyl group, an amino group, an alkoxy group, a carbonyl group, and the like. These functional groups are not particularly limited as long as they have reactivity with the curing agent (B) or reactivity such as self-polymerization of the resins (A). Further, the functional group equivalent thereof is 400 g/eq or more and 10000 g/eq or less. When the functional group equivalent is less than 400 g/eq, the crosslinking density becomes high density, so that the cured product becomes brittle, resulting in reduction of the stretchability. On the other hand, when the functional group equivalent exceeds 10000 g/eq, the heat resistance is reduced because the crosslinking density becomes a lower density. More preferable functional group equivalent is 500 g/eq or more and 8000 g/eq or less, and more preferably 1000 g/eq or more and 6000 g/eq or less.

Further, the resin (A) of the present embodiment is further characterized in that the Tg or softening point is 40° C. or less, or the elastic modulus at 30° C. is less than 1.0 GPa.

When the Tg or softening point of the resin (A) exceeds 40° C., the elastic modulus at around room temperature becomes higher, so that flexibility at room temperature decreases. The lower limit value of the Tg or softening point is not particularly limited, and the lower the Tg or softening point is, the more flexibility and stretchability at room temperature are improved. However, when the Tg or softening point is lower than −40° C., stickiness such as tackiness is likely to occur, so that the Tg or softening point of the resin (A) is preferably −40° C. or higher, more preferably −30° C. or higher.

Alternatively, when the elastic modulus at 30° C. is 1.0 GPa or more, the internal stress at the time of stretching or deformation becomes higher, resulting in that destruction of the conductive filler, as well as the destruction at the interface between the conductive filler and the resin are likely to be induced. Thus, there is a risk of causing a decrease in the conductivity during stretching. The lower limit value of the elastic modulus at 30° C. is also not particularly limited, but the elastic modulus is preferably 100 kPa or more, more preferably 500 kPa or more from the viewpoint of shape restorability.

In the present embodiment, the weight average molecular weight of the resin (A) is preferably 50,000 or more. Accordingly, it is considered that bleeding hardly occurs when a conductive pattern is printed using the resin composition of the present embodiment. On the other hand, the upper limit value of the weight average molecular weight is not particularly limited, but when the molecular weight exceeds 3,000,000, the viscosity becomes higher and the handling property may be lowered, so that the weight average molecular weight of the resin (A) is preferably in the range of from 50,000 to 3,000,000, and more preferably from 100,000 to 1,000,000.

Further, it is preferable that the molecular structure of the resin (A) is a molecular structure containing at least one member selected from (meth)acrylic acid ester, styrene, and acrylonitrile as a structural element.

Examples of (meth)acrylic acid ester include methyl (meth)acrylate, ethyl (meth)acrylate, propyl (meth)acrylate, butyl (meth)acrylate, heptyl (meth)acrylate, hexyl (meth)acrylate, octyl (meth)acrylate, methyl alkyl (meth)acrylate, ethyl alkyl (meth)acrylate, and the like.

The styrene is not particularly limited as long as it is a styrene type compound, and examples of the styrene type compound include styrene, alkylated styrene, halogenated styrene, divinylbenzene, and the like.

The nitrile can be used without particular limitation as long as it contains a cyano group, and specific examples thereof include (meth)acrylonitrile and the like.

Further, for the purpose of imparting a function, a (meth)acrylate-based compound such as glycidyl (meth)acrylate or a compound having an internal unsaturated bond, such as butadiene, may be used.

The molecular structure of the resin (A) may have a single structural element or a plural kinds of structural elements may be used in an arbitrary proportion, and it is preferable to use a plurality of structural elements as the molecular structure in consideration of weather resistance, heat resistance, flexibility, reactivity, compatibility, oil resistance, chemical resistance, water resistance, cold resistance, aging resistance, ozone resistance, gas permeability, abrasion resistance, bending resistance, elongation, tensile strength, tear strength, electric characteristics, etc.

Specific examples of the resin (A) of the present embodiment preferably include epoxy-modified (meth)acrylic acid ester, hydroxyl group-modified (meth)acrylic acid ester, carboxyl group-modified (meth)acrylic acid ester, and the like.

Further, the conductive resin composition of the present embodiment may contain a resin other than the resin (A), and an epoxy resin, a urethane resin, an acrylic resin, a fluoro resin, a silicone resin or the like may also be added in accordance with purposes.

<(B) Curing Agent>

As the curing agent (B) contained in the conductive resin composition of the present embodiment, various curing agents can be used without particular limitation as long as they have reactivity with the resin (A) as described above. Specific examples of the curing agent (B) include a radical generator and a photoacid generator, such as an imidazole-based compound, an amine-based compound, a phenol-based compound, an acid anhydride-based compound, an isocyanate-based compound, a mercapto-based compound, an onium salt, a peroxide, and the like.

<(C) Conductive Filler>

The conductive filler (C) used in the present embodiment is characterized by being made of a conductive material having a volume specific resistivity at room temperature of 1×10⁻⁴ Ω·cm or less. When a material having a volume specific resistivity of more than 1×10⁻⁴ Ω·cm at room temperature is used, the volume resistivity when made into a conductive resin composition is about from 1×10⁻³ Ω·cm to 1×10⁻² Ω·cm, though it depends on the blending amount. Therefore, when made into a circuit, the resistance value increases and power loss increases.

Specifically, examples of the conductive material having a volume specific resistivity of 1×10-4 Ω·cm or less at room temperature include elements and compounds (e.g. oxides, nitrides, carbides, and alloys containing these elements), such as silver, copper, gold, aluminum, magnesium, tungsten, cobalt, zinc, nickel, brass, molybdenum, tantalum, niobium, iron, platinum, tin, chromium, lead, titanium, manganese, stainless steel, and nichrome. Besides the conductive filler (C), a conductive auxiliary agent which is conductive or semi-conductive may be added for the purpose of further improving the conductivity. As such a conductive or semi-conductive auxiliary agent, it is possible to use a conductive polymer, an ionic liquid, a carbon black, an acetylene black, a carbon nanotube, an inorganic compound used for antistatic agents, etc., and these auxiliary agents may be used singly or in combination of two or more kinds thereof at the same time.

In the present embodiment, the shape of the conductive filler (C) is preferably flat, and it is preferable that an aspect ratio of the thickness and the in-plane longitudinal direction be 10 or more. When the aspect ratio is 10 or more, the surface area with respect to the mass ratio of the conductive filler is increased, and not only the efficiency of conductivity is increased, but also the adhesion to the resin component is improved to result in improvement of the stretchability.

From the viewpoint that better conductivity and printability can be secured when the aspect ratio is 1,000 or less, the aspect ratio is preferably 10 or more and 1000 or less, more preferably 20 or more and 500 or less.

An example of the conductive filler having such an aspect ratio is a conductive filler having a tap density of 6.0 g/cm³ or less as measured by a tap method. Further, when the tap density is 2.0 g/cm³ or less, such a tap density is more preferable because the aspect ratio further increases.

The particle size of the conductive filler (C) of the present embodiment is not particularly limited, but from the viewpoint of the printability at the time of screen printing and the appropriate viscosity in the kneading of the composition, it is preferable that the average particle size measured by laser light scattering method (50% volume cumulative diameter: D50) is 0.5 μm or more and 30 μm or less, more preferably 1.5 μm or more and 20 μm or less.

Further, in this embodiment, the conductive filler (C) is preferably a conductive filler whose surface is subjected to coupling treatment. Alternatively, a coupling agent may be contained in the resin composition of the present embodiment. Thereby, there is an advantage that adhesion between the binder resin and the conductive filler is further improved.

As a coupling agent to be added to the resin composition or for subjecting the conductive filler to coupling treatment, there is no particular limitation on the coupling agent as long as it is adsorbed on the surface of the filler or reacts with the surface of the filler. Specifically, examples of the coupling agent include a silane coupling agent, a titanate coupling agent, an aluminum coupling agent, and the like.

In the case of using the coupling agent in the present embodiment, the addition amount thereof is preferably about from 1% by mass to 20% by mass with respect to the whole resin composition.

<Compounding Ratio>

The proportion of each component in the resin composition is not particularly limited as long as it can exhibit the effect of the present invention, and the compounding ratio of the resin (A) and the curing agent (B) may be appropriately determined depending on the type of the resin and the curing agent in consideration of the equivalent ratio.

Regarding the compounding ratio of the conductive filler (C) in the resin composition, it is preferably from 40 to 95% by mass in terms of mass ratio with respect to the total amount of the conductive resin composition in terms of conductivity, cost, and printability, more preferably from 60 to 85% by mass.

<Other Components>

In addition to the above essential components, additives and the like can be added to the resin composition of this embodiment depending on the purpose. Examples of the additives and the like include elastomers, surfactants, dispersants, colorants, fragrances, plasticizers, pH adjusters, viscosity modifiers, ultraviolet absorbers, antioxidants, lubricants, and the like. Among these, it is preferable to add at least one of a surfactant (D), a diluting solvent (E) and a dispersing agent (F).

<(D) Surfactant>

In the resin composition of the present embodiment, it is preferable to compound a surfactant (D) for lowering the surface tension from the viewpoint that the kneadability at the time of compounding, the printability at the time of operation, and the adhesiveness to the substrate are improved. Such a surfactant (D) can be used without any particular limitation as long as it is intended to reduce the surface tension, but for example, an ionic surfactant or a nonionic surfactant can be used. More specifically, a surfactant such as an alkali metal salt of a carboxylic acid ester can be used as the ionic surfactant, and examples of the usable nonionic surfactant include a silicone-based oligomer or copolymer, a fluorine-based oligomer or copolymer, an acrylic-based oligomer or copolymer, and the like.

The amount of the surfactant (D) to be added is preferably about from 0.01 to 50% by mass with respect to the total amount of the conductive resin composition excluding the conductive filler (C) in the entire amount of the conductive resin composition. Such an addition amount in the above range is preferable from the viewpoint of improving kneadability, printability and adhesiveness. A more preferable addition amount of the surfactant (D) is from 0.05 to 35% by mass.

<(E) Diluent>

In the present embodiment, it is preferable to further contain a diluting solvent (E) for the purpose of adjusting the viscosity or controlling workability and pot life during printing. As the diluting solvent, for example, organic solvents such as hydrocarbon type, ketone type, ester type, ether type, glycol type, glycol ester type, glycol ether type, and glyme type may be used, and these solvents may be used singly or in combination of two or more thereof.

Specific examples of the hydrocarbon type solvent include toluene, xylene, solvent naphtha, hexane, isohexane, cyclohexane, ethylcyclohexane, methylcyclohexane, heptane, isooctane, decane, pentane, isopentane, isododecane, and the like.

Specific examples of the ketone type solvent include acetone, methyl ethyl ketone, methyl isobutyl ketone, diisobutyl ketone, cyclohexanone, diacetone alcohol, and the like.

Specific examples of the ester type solvent include ethyl acetate, methyl acetate, butyl acetate, methoxybutyl acetate, amyl acetate, propyl acetate, isopropyl acetate, ethyl lactate, methyl lactate, butyl lactate, and the like.

Specific examples of the ether type solvent include isopropyl ether, methyl cellosolve, ethyl cellosolve, butyl cellosolve, dioxane, methoxymethyl propane, and the like.

Specific examples of the glycol type solvent include ethylene glycol, diethylene glycol, triethylene glycol, propylene glycol, and the like.

Specific examples of glycol ester type solvent include ethylene glycol monoethyl ether acetate, propylene glycol monomethyl ether acetate, diethylene glycol monobutyl ether acetate, diethylene glycol monoethyl ether acetate, and the like.

Specific examples of glycol ether type solvent include methyl carbitol, ethyl carbitol, butyl carbitol, methyltriglycol, propylene glycol monomethyl ether, propylene glycol monobutyl ether, methoxymethyl butanol, diethylene glycol monohexyl ether, propylene glycol monomethyl ether propionate, dipropylene glycol methyl ether, and the like.

Specific examples of the glyme type solvent include ethylene glycol dimethyl ether, diethylene glycol dimethyl ether, ethylene glycol diethyl ether, diethylene glycol diethyl ether, triethylene glycol dimethyl ether, diethylene glycol dibutyl ether, dimethoxy tetraethylene glycol, dipropylene glycol dimethyl ether, and the like.

Examples of the other solvent include dichloromethane, trichloroethylene, perchloroethylene, γ-butyrolactam, ethylpyrrolidone, methylpyrrolidone, tetrahydrofuran, dimethylformamide, dibasic acid ester, ethyl ethoxypropionate, tetramethylene sulfone, dimethyl carbonate, diethyl carbonate, styrene monomer, acetonitrile, dioxolane, γ-butyrolactone, dimethyl sulfoxide, dioctyl phthalate, diisonyl phthalate, dibutyl phthalate, dimethyl succinate, diethyl succinate, and the like.

<(F) Dispersant>

In the resin composition of the present embodiment, it is preferable to further add a dispersant (F) for the purpose of improving the dispersion stability of the conductive filler and the resin. The dispersant is not particularly limited as long as the effect as a dispersant is exhibited, but examples thereof include a copolymer containing an acid group, a block copolymer having pigment affinity, a phosphate ester-based compound, a polyether phosphate ester-based compound, a fatty acid ester-based compound, an alkylene oxide copolymer, a modified polyether polymer, a fatty acid derivative, a urethane polymer, and the like. Examples of commercially available dispersants include DISPERBYK series manufactured by Bigchemie Corp.; SOLSPERSE series manufactured by Lubrizol Japan LLC; SOKALAN, TAMOL, and Efka series manufactured by BASF Corporation; NUOSPERSE series manufactured by Elementis PLC.; DISPARLON series manufactured by Kusumoto Chemicals, Ltd.; FLORENE series manufactured by Kyoeisha Kagakusha KK.; AJISPER series manufactured by Ajinomoto Fine-Techno Co., Inc., and the like.

<Method for Preparing Conductive Resin Composition>

The method for preparing the conductive resin composition of the present embodiment is not particularly limited. For example, first, the resin (A), the curing agent (B), the conductive filler (C), and various additives and/or the diluting solvent (E) as needed are uniformly mixed, so that the resin composition of the present embodiment can be obtained. If necessary, an organic solvent or the like for adjusting the viscosity may be added.

<Formation of Conductive Pattern, Etc. And Electronic Circuit Member Using the Same>

By applying or printing the conductive resin composition of the present embodiment on a substrate such as a film or a woven fabric, a coating film of the conductive resin composition can be formed to produce a desired conductive pattern, a conductive film or the like. The present invention also encompasses an electronic circuit member having such a conductive pattern or a conductive film.

In the present embodiment, various films, woven fabrics, etc. can be used as a substrate to be a target for forming a conductive pattern or a conductive film. Specifically, for example, in addition to organic films such as polyester, polypropylene, polycarbonate, polyethylene sulfone, urethane, and silicon, it is possible to use, without any particular limitation, fiber-reinforced plastics used for printed wiring boards, and woven fabric made of fibers such as polyester, rayon, acryl, wool, cotton, hemp, silk, polyurethane, nylon, and cupra as long as it can apply the conductive resin composition or withstand printing.

The conductive pattern and the conductive film can be formed by the following steps. That is, first, a coating film is formed by applying or printing the resin composition of the present embodiment on a substrate, and volatile components contained in the coating film are removed by drying. The conductive film or the conductive pattern can be formed by a step of curing the resin (A) and the curing agent (B) through a subsequent curing step such as heating, electron beam irradiation or light irradiation, and a step of reacting the coupling agent and the conductive filler (C) and reacting the resin (A) and the curing agent (B). The conditions in each of the curing step and the reaction step are not particularly limited and may be appropriately set depending on the type of the resin, the curing agent, the filler, etc. and the desired form.

The step of applying the conductive resin composition (conductive paste) of the present embodiment on the substrate is not particularly limited, but, for example, a coating method using an applicator, a wire bar, a comma roll, a gravure roll and the like, and a printing method using a screen, a flat plate offset, a flexo printing, an ink jet, a stamping printing, a dispenser, a squeegee, or the like can be used.

As described above, according to the present invention, it becomes possible to provide a conductive resin composition which satisfies good restorability after deformation, high heat resistance, electrical conductivity and stretchability at the same time, and a circuit member made of the same. Further, by using the conductive resin composition or the circuit member having such characteristics, it is considered that various interface devices such as sensors and displays, which are required to be mountable and have shape followability, can be realized. In addition, the conductive resin composition of the present invention is widely applicable to applications requiring mountability and shape followability to free-curved surfaces in flexible batteries including solar cells, or in the medical field or in the vehicle field.

Hereinafter, the present invention will be described more specifically with reference to examples, but the scope of the present invention is not limited thereto.

### Examples

First, various materials used in these examples are as follows.

(Resin)

(A) Resin 1: Epoxy-modified acrylic acid ester resin “PMS-14-2” (epoxy equivalent: 1852 g/eq, molecular weight: 1,000,000, Tg: −35° C., manufactured by Nagase ChemteX Corporation)

(A) Resin 2: Hydroxyl group-modified acrylic acid ester resin “SG-600TEA” (hydroxyl group equivalent: 2805 g/eq, molecular weight: 1,200,000, Tg: −37° C., manufactured by Nagase ChemteX Corporation)

(A) Resin 3: Epoxy-modified acrylic acid ester resin “SG-P3 improved 215” (epoxy equivalent: 5,000 g/eq, molecular weight: 850,000, Tg: −10° C., manufactured by Nagase ChemteX Corporation)

Resin having a low functional group equivalent: Bisphenol A type epoxy resin “EPICLON 850S” (manufactured by DIC Corporation, epoxy equivalent: 185 g/eq, molecular weight: 370, liquid at room temperature)

Resin having a high softening point: Bisphenol A type epoxy resin “1003” (epoxy equivalent: 750 g/eq, molecular weight: 1500, softening point 90° C., manufactured by Mitsubishi Chemical Corporation)

Thermoplastic resin: Thermoplastic polyurethane resin “MIRACTRAN P22M” (no functional group, Tg: −40° C., manufactured by Nippon Miractran Co., Ltd.)

((B) Curing Agent)

Amine-based compound: Bifunctional polyether amine “D2000” (manufactured by Mitsubishi Kagaku Fine K.K.)

Isocyanate-based curing agent: Polyisocyanate “DN-950” manufactured by DIC Corporation

Imidazole-based curing accelerator: 2-Ethyl-4-methylimidazole “2E4MZ” (manufactured by Shikoku Chemicals Corporation)

Phenol-based curing agent: Biphenyl aralkyl type phenol resin “GPH-103” (manufactured by Nippon Kayaku Co., Ltd.)

(Conductive Filler)

(C) Conductive filler 1: Silver powder “Ag-XF-301” (specific surface area 2.0 m²/g, tap density 0.56 g/cm³, manufactured by Fukuda Metal Foil & Powder Co., Ltd.)

(C) Conductive filler 2: Silver powder “AgC-204B” (specific surface area 2.4 m²/g, tap density 2.1 g/cm³, manufactured by Fukuda Metal Foil & Powder Co., Ltd.)

Conductive filler with high resistivity: Acetylene black “HS-100” (specific surface area 39 m²/g, tap density 0.2 g/cm³, electrical resistivity 0.14 Ωcm, manufactured by Denka Company Limited)

((D) Surfactant)

Polyester modified silicone-based surface conditioner: “BYK-370” (manufactured by BYK Japan KK)

Fluorine-based surfactant: “FTX-218” (manufactured by Neos Corporation)

((E) Solvent)
Cyclohexanone

((F) Dispersant)

Block copolymer type wet dispersant “DISPERBYK-2155” (manufactured by BYK Japan KK)

(Coupling Agent)

Glycidoxypropyltrimethoxysilane “KBM-403” (manufactured by Shin-Etsu Silicone Co., Ltd.)

Decyltrimethoxysilane “KBM-3103” (manufactured by Shin-Etsu Silicone Co., Ltd.)

### Examples 1 to 10 and Comparative Examples 1 to 5

1. Preparation of Resin Composition

Each component was added to a solvent (cyclohexanone) in the formulation composition (parts by mass) shown in the following Table 1 and stirred by a planetary centrifugal mixer (“ARV-310” manufactured by THINKY) at 2,000 rpm for 3 minutes. Thereby, the components were homogeneously mixed to prepare a conductive resin composition.

2. Evaluation

### (Volume Resistance Value)

Each of the conductive resin compositions obtained above was applied on a PET substrate (PET-O2-BU, manufactured by Mitsui Chemicals Tohcello, Inc.) so as to have a thickness of 50 μm after drying, and then subjected to heating in an electric oven at 100° C. for 10 minutes and at 170° C. for 1 hour.

Resistance measurement (MCP-T370, manufactured by Mitsubishi Chemical Analytech Co., Ltd.) was performed on the obtained sample surfaces of each of examples and comparative examples by a four-terminal method, and the result was taken as a volume resistance value.

(Measurement of Resistance Change During Stretching)

Each of the conductive resin compositions obtained above was printed on a substrate (Sewfree 3412, manufactured by BEMIS Company) with a metal mask having a thickness of 60 μm, and a conductor pattern of JIS dumbbell No. 6 was printed. Thereafter, the substrate was heated in an electric oven at 100° C. for 10 minutes and at 170° C. for 1 hour. The obtained printed substrate was fixed to a manual film stretcher. At that time, the dumbbell gripping part was connected to the resistance meter with a copper wire interposed therebetween, and the resistance value before stretching and the resistance value at the time of stretching were recorded. The operation was repeated ten times, and the amount of resistance fluctuation from the initial value was calculated in 100 fractions, and the average value was measured as an average of resistance fluctuation during a repeated 10% stretching for 10 times.

(Measurement of Residual Strain)

In a similar manner to the preparation of the film of the conductive resin composition for measuring the volume resistivity, each conductive resin composition was applied on a PET substrate (PET-O2-BU, manufactured by Mitsui Chemicals Tohcello, Inc.) to have a thickness after drying of 50 μm and heated in an electric oven at 100° C. for 10 minutes and at 170° C. for 1 hour. Thereafter, the substrate was cut into a JIS dumbbell No. 6 pattern to obtain a conductive resin composition film sample for tensile compression test. The effective elongation length was extended to 25%, and the state was held for 5 minutes. Then the operation to return the position to the 0% position at the same speed was performed, and the residual strain was measured. The strain length was measured as the ratio of the distance between the clamps of the sample.

The above evaluation results are shown in Table 1.

TABLE 1

| | Item | Product name | Example 1 | Example 2 | Example 3 | Example 4 | Example 5 | Example 6 |
|---|---|---|---|---|---|---|---|---|
| Compounding | (A) Resin | PMS-14-2 | 10.0 | | | 10.0 | 7.0 | |
| material | | SG-600TEA | | 10.0 | | | | |
| | | SG-P3 | | | 10.0 | | | 8.0 |
| | Epoxy resin having functional | EPICLON8505 | | | | | 3.0 | |
| | equivalent 400 g/eq or less | | | | | | | |
| | Epoxy resin having softening point of | jER1003 | | | | | | |
| | 40 degrees of higher | | | | | | | |
| | Thermoplastic polyurethane resin | MIRACTRAN | | | | | | 2.0 |
| | | P22M | | | | | | |
| | (B) Curing agent | D2000 | 2.7 | | 1.0 | | 10.0 | 0.8 |
| | | DN-950 | | 0.9 | | | | |
| | | 2E4MZ | 0.1 | | 0.1 | 0.1 | 0.1 | 0.1 |
| | | GPH-103 | | | | 1.2 | | |
| | (C) Conductive filler | Ag-XF301 | 50.0 | 50.0 | 70.0 | | 40.0 | 35.0 |
| | | FA-S-10 | | | | 80.0 | | |
| | Conductive filler with high resistivity | HS-100 | | | | | | |
| | (D) Surfactant | BYK-370 | 0.5 | 0.5 | | 0.5 | 0.5 | |
| | | FTX-218 | | | 0.5 | | | 0.5 |
| | (E) Solvent | Cyclohexanone | 2.0 | 2.0 | 2.0 | 2.0 | 2.0 | 2.0 |
| | (F) Dispersent | DISPERBYK- | 0.2 | 0.2 | 0.2 | 0.2 | 0.2 | 0.2 |
| | | 2155 | | | | | | |
| | Coupling agent | KBM-403 | 0.2 | | 0.2 | | 0.2 | 0.2 |
| | | KBM-3103 | | 0.2 | | 0.2 | | |
| Printed matter | Volume resistivity | ×10 − 4 Ω · cm | 1 | 1 | 1 | 3 | 1 | 1 |
| after drying/ | Average of resistance fluctuation during | % | 200 | 300 | 150 | 250 | 200 | 300 |
| curing | repeated 10% stretching for 10 times | | | | | | | |
| | Residual strain after 25% elongation | % | 9 | 10 | 12 | 15 | 9 | 10 |

| | | | | | | Example | Example | Comparative |
|---|---|---|---|---|---|---|---|---|
| | Item | Product name | Example 7 | Example 8 | Example 9 | 10 | 11 | example 1 |
| Compounding | (A) Resin | PMS-14-2 | | 10.0 | | | 10.0 | |
| material | | SG-600TEA | 10.0 | | | 10.0 | | |
| | | SG-P3 | | | 10.0 | | | |
| | Epoxy resin having functional | EPICLON8505 | | | | | | 10.0 |
| | equivalent 400 g/eq or less | | | | | | | |
| | Epoxy resin having softening point of | jER1003 | | | | | | |
| | 40 degrees of higher | | | | | | | |
| | Thermoplastic polyurethane resin | MIRACTRAN | | | | | | |
| | | P22M | | | | | | |
| | (B) Curing agent | D2000 | | 2.7 | | | 2.7 | |
| | | DN-950 | 0.9 | | | 0.9 | | |
| | | 2E4MZ | | 0.1 | 0.1 | | 0.1 | 0.1 |
| | | GPH-103 | | | 0.5 | | | |
| | (C) Conductive filler | Ag-XF301 | 10.0 | 50.0 | | 50.0 | 50.0 | 50.0 |
| | | FA-S-10 | | | 65.0 | | | |
| | Conductive filler with high resistivity | HS-100 | 2.0 | | | | | |
| | (D) Surfactant | BYK-370 | 0.5 | | | | | 0.5 |
| | | FTX-218 | | | | 0.5 | 0.5 | |
| | (E) Solvent | Cyclohexanone | 2.0 | 2.0 | 2.0 | 2.0 | 2.0 | 2.0 |
| | (F) Dispersent | DISPERBYK- | 0.2 | | 0.2 | | 0.2 | 0.2 |
| | | 2155 | | | | | | |
| | Coupling agent | KBM-403 | | | 0.2 | | | 0.2 |
| | | KBM-3103 | 0.2 | | | 0.2 | | |
| Printed matter | Volume resistivity | ×10 − 4 Ω · cm | 0.8 | 1 | 2 | 1 | 1 | 1 |
| after drying/ | Average of resistance fluctuation during | % | 150 | 250 | 200 | 300 | 150 | 1500 |
| curing | repeated 10% stretching for 10 times | | | | | | | |
| | Residual strain after 25% elongation | % | 12 | 15 | 9 | 10 | 12 | — |

| | | | Comparative | Comparative | Comparative | Comparative |
|---|---|---|---|---|---|---|
| | Item | Product name | example 2 | example 3 | example 4 | example 5 |
| Compounding | (A) Resin | PMS-14-2 | 10.0 | | 10.0 | |
| material | | SG-600TEA | | | | |
| | | SG-P3 | | | | |
| | Epoxy resin having functional | EPICLON8505 | | | | |
| | equivalent 400 g/eq or less | | | | | |
| | Epoxy resin having softening point of | jER1003 | | | | 10.0 |
| | 40 degrees of higher | | | | | |
| | Thermoplastic polyurethane resin | MIRACTRAN | | 10.0 | | |
| | | P22M | | | | |
| | (B) Curing agent | D2000 | 2.7 | | 2.7 | |
| | | DN-950 | | | | |
| | | 2E4MZ | | | 0.1 | 0.1 |
| | | GPH-103 | | | | |
| | (C) Conductive filler | Ag-XF301 | 50.0 | 50.0 | | 50.0 |
| | | FA-S-10 | | | | |
| | Conductive filler with high resistivity | HS-100 | | | 50.0 | |
| | (D) Surfactant | BYK-370 | 0.5 | | 0.5 | |
| | | FTX-218 | | | | |
| | (E) Solvent | Cyclohexanone | 2.0 | | 2.0 | |
| | (F) Dispersent | DISPERBYK- | 0.2 | | 0.2 | |
| | | 2155 | | | | |
| | Coupling agent | KBM-403 | 0.2 | | 0.2 | |
| | | KBM-3103 | | | | |
| Printed matter | Volume resistivity | ×10 − 4 Ω · cm | 1 | 1 | 100 | 1 |
| after drying/ | Average of resistance fluctuation during | % | 200 | 400 | 200 | — |
| curing | repeated 10% stretching for 10 times | | | | | |
| | Residual strain after 25% elongation | % | 30 | 30 | 15 | — |

(Results/Discussion)

As described above, in Examples 1 to 11 where the conductive resin compositions of the present invention were used, it was confirmed that such compositions showed also a low volume resistivity, a high conductivity, a small resistance fluctuation at 10 times stretching, a small residual strain, and a good restorability.

On the other hand, in Comparative Example 1 using an epoxy resin having a small functional group equivalent, the resistance fluctuation during stretching was large. Further, in Comparative Example 2 in which the curing agent (B) of the present invention was not used and in Comparative Example 3 in which a thermoplastic resin was used as the resin, the residual strain was large and the restoration was hardly observed. In Comparative Example 4 in which the conductive filler (C) of the present invention was not added, the resistance value was high. In Comparative Example 5 using a resin having a softening point higher than that specified in the present invention as a resin, there was almost no stretchability and the resin composition fractured during the tensile test.

In order to embody the present invention, the present invention has been appropriately and adequately explained by means of the specific embodiments, but it should be recognized that a person skilled in the art could easily amend and/or reform the embodiments. Therefore, as long as amended or reformed modes carried out by a person skilled in the art do not depart from the scope of the claims described in the claims of the present invention, these amended or reformed modes are interpreted as being encompassed by the scope of the claims.

1. A conductive resin composition comprising, as essential components, a resin (A), a curing agent (B) reacting with the resin (A), and a conductive filler (C), wherein the resin (A) has a functional group, a functional group equivalent of 400 g/eq or more and 10,000 g/eq or less, a Tg (glass transition temperature) or a softening point of 40° C. or less, or an elastic modulus of less than 1.0 GPa at 30° C., and wherein the conductive filler (C) is made of a conductive material having a volume specific resistivity of 1×10⁻⁴ Ω·cm or less at room temperature.

2. The conductive resin composition according to claim 1, wherein the resin (A) has a weight average molecular weight of 50,000 or more.

3. The conductive resin composition according to claim 1, wherein the molecular structure of the resin (A) contains at least one selected from (meth)acrylic acid ester, styrene, and acrylonitrile as the component.

4. The conductive resin composition according to claim 1, wherein the conductive filler (C) has a flat shape, and an aspect ratio of the thickness and the in-plane longitudinal direction is 10 or more.

5. The conductive resin composition according to claim 1, wherein the compounding ratio of the conductive filler (C) is from 40 to 95% by mass in terms of mass ratio to the total amount of the conductive resin composition.

6. The conductive resin composition according to claim 1, further comprising a surfactant (D) for lowering the surface tension.

7. The conductive resin composition according to claim 6, wherein the surfactant (D) is contained in an amount of 0.01 to 50% by mass with respect to the entire amount of the conductive resin composition excluding the conductive filler.

8. The conductive resin composition according to claim 1, further comprising a diluent (E).

9. The conductive resin composition according to claim 1, further comprising a dispersant (F) for improving the dispersion stability of the resin (A) and the conductive filler (C).

10. The conductive resin composition according to claim 1, further comprising a coupling agent.

11. The conductive resin composition according to claim 1, wherein the conductive filler (C) is a conductive filler whose surface is subjected to a coupling treatment.

12. An electronic circuit member having a conductive pattern or a conductive film made of the conductive resin composition according to claim 1.
